(19) United States
(12) Patent Application Publication
(10) Pub. No.: US 2013/0137850 A1
(43) Pub. Date: May 30, 2013

(54) NOVEL POLYMER AND PROCESS FOR PRODUCING THE SAME

(71) Applicant: Jnc Corporation, Tokyo (JP)

(72) Inventors: Tomohiro YOSHIMURA, Yokohama-shi (JP); Tsuyoshi NAKAMA, Yokohama-shi (JP); Eri IWAMOTO, Yokohama-shi (JP)

(73) Assignee: JNC CORPORATION, Tokyo (JP)

(21) Appl. No.: 13/688,988

(22) Filed: Nov. 29, 2012

(30) Foreign Application Priority Data
Nov. 30, 2011 (JP) 2011-261127

(51) Int. Cl. C08B 37/08

(52) U.S. Cl. CPC C08B 37/0072
USPC 530/322

(57) ABSTRACT

An objective of the invention is to provide an excellent biomaterial having a good operability and a high safety; the solution is a polymer having one or more peptide units represented by formula (1) as described below and one or more saccharide residues derived from polysaccharides:

-(Pro-Y-Gly)n- (1)

wherein, Y represents Pro or Hyp and n is an integer of 1 or more; the invention provides a novel polymer having both various characteristics of a collagen-like polypeptide suitable for a biomaterial, and characteristics of polysaccharides, namely, a high hydrophilicity and enzymolytic degradation, and also having a high mechanical strength and water absorbing properties; furthermore, the water absorbing properties and enzymolysis properties of the resultant polymer can be controlled by changing an amount of charging the peptide oligomer and the polysaccharides in a condensation reaction.

This is a Non-Provisional application, which claims priority to Japanese Patent Application No. 2011-261127, filed on Nov. 30, 2011; the contents of which are all herein incorporated by this reference in their entireties. All publications, patents, patent applications, databases and other references cited in this application, all related applications referenced herein, and all references cited therein, are incorporated by reference in their entirety as if restated here in full and as if each individual publication, patent, patent application, database or other reference were specifically and individually indicated to be incorporated by reference.

### TECHNICAL FIELD

The present invention relates to a novel polymer and a process for producing the same.

### BACKGROUND ART

A biomaterial, particularly, a medical biomaterial is required to have bioaffinity, compatibility with a bodily fluid such as blood or a tissue, and neither toxicity nor antigenicity, or the like. From such a viewpoint, a collagen or hyaluronic acid that is derived from a living body, excellent in bioaffinity and biocompatibility, and degraded and absorbed within the living body is widely utilized.

The collagen is a fibrous protein found in all multicellular animals, and occupies 25% of the total proteins in mammals as a main component of a skin or bone. The collagen has many excellent properties, such as promotion of adhesion or growth of cells, having a triple helical structure and induced platelet aggregation activity, a low antigenicity, a high bioaffinity and biodegradability. Therefore, the collagen is effectively used in various applications, such as a material for a cell experiment and a medical material, in various forms such as an aqueous solution, a flock, a film, a sponge and a gel. The collagen has been actively studied as an important material in regenerative medical treatment in recent years.

However, most of the collagens used as the biomaterial have been collected so far from livestock tissues, such as a bovine hide, but a Bovine Spongiform Encephalopathy (BSE) problem has come up to the surface in recent years. If a collagen in which a material derived from livestock, including the material derived from the bovine hide, is used for human beings, inspection by the pathogenic organism is concerned.

Then, from a viewpoint of safety, an amount of resources, or the like, a collagen derived from fish attracts lots of attention and is currently used as a cell carrier, or a medical material and a cosmetic surgery material. However, the collagen derived from fish has problems of an inadequate thermal stability and an inadequate in vivo stability, a poor operability for providing the collagen for a medical material application and a cosmetic surgery material application, and a too high in vivo absorption.

Moreover, a highly safe collagen-like polypeptide without a risk of infection by a pathogenic organism or transmission of a pathogenic factor is also reported (Patent literature Nos. 1 and 2). However, the collagen-like polypeptides have a high solubility in water. Therefore, the polypeptides have problems of a short in vivo residence time, and no capability of satisfying mechanical stability that may be required depending on an application. Accordingly, a development has been desired for a wide variety of chemically modified products of collagen-like polypeptides.

Meanwhile, hyaluronic acid that is polysaccharides is contained much in an intercellular substance of an animal tissue. Specifically, hyaluronic acid is one of mucopolysaccharides present in an eye vitreous body, an umbilical cord, a synovial fluid, a skin, a cartilage and other connective tissues, and utilized for an ophthalmic surgery drug, an arthrosis therapeutic drug, a postoperative adhesion prevention agent, a wound coating agent, and so forth.

Hyaluronic acid also has properties of a high solubility in water. Therefore, hyaluronic acid also has problems of a short in vivo residence time, and also no capability of satisfying mechanical stability that may be required depending on the application. Then, a wide variety of chemically modified products of hyaluronic acid have been proposed.

As atypical example, a cross-linked hyaluronic acid gel has been obtained by using divinylsulfone, bisepoxides, formaldehyde, dihydrazine, dihydrazide, polyisocyanate or the like as a cross-linking agent (Patent literature Nos. 3 to 5).

However, the cross-linked hyaluronic acid gel disclosed in Patent literature Nos. 4 and 5 has no biodegradability, and when a cross-linking method needing addition of a highly toxic metal catalyst such as dibutyltin dilaurate is applied, the metal catalyst may remain in the resultant hydrogel, and the cross-linked hyaluronic acid gel is not suitable as a biomedical material. Moreover, although mechanical strength also has been improved to some extent, the mechanical strength has been not sufficient enough.

Moreover, in order to solve the problem of mechanical strength, a method for compressing a cross-linked hyaluronic acid sponge has also been developed (Patent literature No. 6). However, a sponge structure has been destroyed, and has been not preferable enough in view of any capability of developing water holding properties.

In addition thereto, a material prepared using a polypeptide such as a collagen, and a saccharide chain such as hyaluronic acid has also been developed. For example, such an art has been reported as a hydrogel in which hyaluronic acid having an introduced phenolic hydroxyl group, and a fibrosed collagen are entangled and contained (Patent literature No. 7), a matrix in which an atelocollagen gel and hyaluronic acid are entangled and constituted (Patent literature No. 8), a matrix in which a polyglycan and a polypeptide are cross-linked by a covalent bond (Patent literature No. 9).

However, an example of reporting a polymer including a collagen-like polypeptide and polysaccharides such as hyaluronic acid has not been found so far.

### CITATION LIST

### Patent Literature

Patent literature No. 1: JP 2003-321500 A.

Patent literature No. 2: JP 2005-53878 A.

Patent literature No. 3: JP H7-97401 A.

Patent literature No. 4: JP H09-59303 A.

Patent literature No. 5: JP 2001-348401 A.

Patent literature No. 6: JP H7-30124 B.

Patent literature No. 7: JP 2007-297360 A.

Patent literature No. 8: JP 2005-152298 A.

Patent literature No. 9: JP 2005-528933 A.

### SUMMARY OF INVENTION

### Technical Problem

An objective of the invention is to provide an excellent biomaterial having a good operability and a high safety.

### Solution to Problem

The present inventors have diligently continued to conduct research in order to solve the problem described above, as a result, have found that a novel polymer obtained by condensing a peptide oligomer including an amino acid sequence of -Pro-Y-Gly- (wherein Y represents Pro or Hyp) and polysaccharides has characteristics of both a collagen-like polypeptide and the polysaccharides, and also has a high mechanical strength, and further water absorbing properties or enzymolysis properties of the resultant polymer can be adjusted by changing an amount of charging the peptide oligomer and the polysaccharides in a condensation reaction, and have completed the invention based on the finding.

The invention concerns a polymer having one or more peptide units represented by formula (1) as described below, and one or more saccharide residues derived from polysaccharides (hereinafter, described as the polymer of the invention):

-(Pro-Y-Gly)ₙ- (1)

wherein Y represents Pro or Hyp and n is an integer of 1 or more.

The invention also concerns a process for producing the polymer, comprising a step for allowing a condensation reaction between a peptide oligomer including the peptide unit represented by formula (1) and the polysaccharides (hereinafter, described as the production process of the invention).

More specifically, the invention is as described below.

Item 1. A polymer having one or more peptide units represented by formula (1) as described below, and one or more saccharide residues derived from polysaccharides:

-(Pro-Y-Gly)ₙ- (1)

wherein Y represents Pro or Hyp and n is an integer of 1 or more.

Item 2. The polymer according to item 1, including a triple helical structure.

Item 3. The polymer according to item 1 or 2, wherein a weight ratio of the peptide unit(s) to the saccharide residue(s) is in the range of 95/5 to 50/50.

Item 4. The polymer according to any one of items 1 to 3, wherein the polysaccharides are selected from hyaluronic acid, carboxylmethyl cellulose, chondroitin sulfate, dextran, heparin and dermatan sulfate.

Item 5. The polymer according to any one of items 1 to 4, further having one or more amino acid residues or one or more peptide units, in addition to the peptide unit(s).

Item 6. The polymer according to item 5, wherein the further amino acid residue(s) is/are a glycine residue(s) or a lysine residue(s).

Item 7. The polymer according to any one of items 1 to 6, wherein the peptide unit and the saccharide residue derived from the polysaccharides are bonded between a carboxyl group thereof and an amino group thereof.

Item 8. A process for producing the polymer according to any one of items 1 to 7, comprising a step for allowing a condensation reaction between a peptide oligomer including the peptide unit represented by formula (1) and the polysaccharides.

### Effects of Invention

The invention provides a novel polymer having both various characteristics of a collagen-like polypeptide suitable for a biomaterial, and characteristics of polysaccharides, namely, a high hydrophilicity and enzymolytic degradation, and also having a high mechanical strength and water absorbing properties. Moreover, a peptide relating to the invention is an artifact, and therefore has no concern of a risk of infection by a pathogenic organism, or the like. Furthermore, the water absorbing properties and enzymolysis properties of the resultant polymer can be controlled by changing an amount of charging the peptide oligomer and the polysaccharides in a condensation reaction.

Accordingly, the invention provides an excellent biomaterial having a good operability and a high safety.

### BRIEF DESCRIPTION OF DRAWINGS

FIG. 1 is a graph showing a weight change when a polymer of the invention as obtained from Production Examples 1, 2, 3 and 6 is swollen with water, and then treated with hyaluronidase.

### DESCRIPTION OF EMBODIMENTS

Hereafter, the invention will be explained in detail.

In the invention, various amino acid residues are described by means of the abbreviations described below.
Ala: L-alanine residue;
Arg: L-arginine residue;
Asn: L-asparagine residue;
Asp: L-aspartic acid residue;
Cys: L-cysteine residue;
Gln: L-glutamine residue;
Glu: L-glutamic acid residue;
Gly: Glycine residue;
His: L-histidine residue;
Hyp: L-hydroxyproline residue;
Ile: L-isoleucine residue;
Leu: L-leucine residue;
Lys: L-lysine residue;
Met: L-methionine residue;
Phe: L-phenylalanine residue;
Pro: L-proline residue;
Sar: Sarcosine residue;
Ser: L-serine residue;
Thr: L-threonine residue;
Trp: L-tryptophan residue;
Tyr: L-tylosin residue; and
Val: L-valine residue.

Moreover, an amino acid sequence of a peptide chain herein is described by drawing an N-terminus of an amino acid residue on a left-hand side and a C-terminus thereof on a right-hand side in accordance with an ordinary process.

A polymer of the invention has one or more peptide units represented by formula (1) as described below (hereinafter, occasionally described as a PYG peptide unit), and one or more a saccharide residues derived from polysaccharides as an essential constituent unit:

-(Pro-Y-Gly)ₙ- (1)

wherein, in formula (1), Y represents Pro or Hyp, and may be either one.

However, Y is further preferably Hyp in a case where stability of a triple helical structure as described later is desirably further improved. In addition, Hyp is not particularly limited, but is ordinarily a 4Hyp residue (a trans-4-hydroxy-L-proline residue, for example).

Moreover, n is an integer of 1 or more, and is not particularly limited. However, the number of n is different depending on a secondary structure that the polymer of the invention can have. Therefore, the number of n will be described later.

The polymer of the invention ordinarily has a primary structure in which the PYG peptide unit and the saccharide residue derived from polysaccharides are bonded by condensation between a carboxyl group and an amino group.

The polysaccharides from which the saccharide residue(s) as an essential constituent unit of the polymer of the invention is derived are not particularly limited, but preferably have the carboxyl group and/or the amino group. Moreover, the polysaccharides are preferably degraded by a glycolytic enzyme. Moreover, one kind or two or more kinds of polysaccharides are contained in the polymer of the invention.

Specific examples of the polysaccharides particularly preferably include glycosaminoglycan such as hyaluronic acid, chondroitin sulfate, heparin and dermatan sulfate, carboxylmethyl cellulose, cellouronic acid, carboxylmethyl chitin and dextran. The polysaccharides may be any one of an extract from a natural plant, a product of microbial fermentation, a synthetic substance by an enzyme or a chemical synthetic substance. Among the polysaccharides, hyaluronic acid that widely exists in vivo and has a high biocompatibility is particularly preferred.

In a case where the polysaccharides are hyaluronic acid, an average molecular weight thereof is preferably at least approximately 10 kDa, further preferably, in the range of approximately 50 to approximately 1,500 kDa from a viewpoint of handling properties of hyaluronic acid as a raw material in a production process of the invention as described later, and strength of the resultant polymer.

Herein, the average molecular weight of hyaluronic acid is expressed in terms of a value obtained by measuring limiting viscosity according to viscosity determination based on the Japanese Pharmacopoeia or a first method of viscosity determination based on the Japanese Standards of Cosmetic Ingredients in a step of the raw material for production according to the invention, and calculating the average molecular weight using the numerical value from an equation as described below.

[η]=0.000403×M^{0.775}

wherein [η] represents limiting viscosity (dl/g) and M represents a molecular weight (Dalton).

Moreover, in a case where the polysaccharides are carboxylmethyl cellulose, an average molecular weight thereof is preferably at least approximately 10 kDa, further preferably, in the range of approximately 50 to approximately 1,000 kDa from a viewpoint of handling properties of carboxylmethyl cellulose as a raw material in the production process of the invention as described later, and the strength of the resultant polymer.

In the polymer of the invention, a weight ratio of the PYG peptide unit(s) to the saccharide residue(s) derived from polysaccharides is not particularly limited, but is preferably in the range of approximately 95/5 to approximately 50/50, further preferably, in the range of approximately 90/10 to approximately 60/40. If the weight ratio is in the range, the polymer of the invention is gelated to be suitable as a biomaterial having a sufficient mechanical strength. Moreover, water absorbing properties and an enzymolysis rate as described later can be easily controlled.

The weight ratio can be adjusted by changing a ratio of charging a peptide oligomer including the PYG peptide unit(s) and the polysaccharides as the raw materials in a condensation reaction in the production process of the invention as described later.

The polymer of the invention may have a further constituent unit, in addition to the PYG peptide unit(s) and the saccharide residue(s) derived from polysaccharides within the range in which advantageous effects of the invention are not adversely affected. The further constituent unit is not particularly limited. Specific examples include one or more amino acid residues, one or more peptide units or alkylene.

The amino acid residue as the further constituent unit is not particularly limited. Specific examples include at least one kind of amino acid residues selected from Ala, Arg, Asp, Cys, Gln, Glu, Gly, His, Hyp, Ile, Leu, Lys, Met, Phe, Pro, Sar, Ser, Thr, Trp, Tyr and Val. Among the amino acid residues, in a case where the further amino acid residue is Gly, the further amino acid residue can provide the polymer of the invention with transparency. Moreover, in a case where the further amino acid residue is Lys, the further amino acid residue can provide the polymer of the invention with flexibility.

The peptide unit as the further constituent unit is not particularly limited. Specific examples include a unit in which two or more amino acid residues as described above are subjected to peptide bonding. For example, in a case where the further peptide unit is a peptide unit represented by formula (2) as described below, when the polymer of the invention is provided for an application to a cell scaffold material or the like, the further peptide unit can improve cellular adhesiveness of the material. Moreover, in a case where the further peptide unit is a peptide unit represented by formula (3) as described below, the further peptide unit can provide the polymer of the invention with properties showing a solution-gelation behavior in response to temperature:

-(Arg-Gly-Asp)- (2)

or

-(Val-Pro-Gly-Val-Gly)- [SEQ ID NO: 1] (3).

Alkylene as the further constituent unit may be either straight-chain alkylene or branched-chain alkylene, and is not particularly limited. Specific examples include alkylene having 1 to 18 carbons, preferably, alkylene having 2 to 12 carbons for practical purposes.

In the polymer of the invention, a ratio at which the further constituent unit(s) is included is preferably in the range of approximately 0.1 to approximately 20% by weight, further preferably, in the range of approximately 0.1 to approximately 10% by weight, still further preferably, in the range of approximately 0.1 to approximately 5% by weight, based on the total of the polymer. If the ratio is within the range, the further constituent unit improves the strength of the resultant polymer without adversely affecting advantageous effects of the invention.

The polymer of the invention preferably includes the triple helical structure.

The amino acid sequence represented by formula (1) contributes to formation of a triple helix. Thus, in a case where n as the number of repetition in formula (1) is approximately 5 or more in the polymer, the PYG peptide unit in the polymer of the invention can form a triple helical secondary structure. Then, n as the number of repetition is preferably in the range of approximately 5 to approximately 100,000, further preferably, in the range of approximately 10 to approximately 50,000.

In a case where the polymer of the invention includes the triple helical structure, the polymer is formed into a water-insoluble hydrogel, and stronger, as compared with a polymer without including the triple helical structure. Furthermore, the polymer has induced platelet aggregation activity.

In addition, in a case where n as the number of repetition in formula (1) is in the range of approximately 1 to approximately 4, the PYG peptide unit in the polymer of the invention does not form the triple helical structure, and the polymer of the invention is soluble in water and formed into a gelatin-like product.

Whether or not the triple helical structure is formed in the polymer of the invention can be confirmed by measuring a circular dichroism spectrum of a dispersion liquid of the polymer or an enzymolysis solution thereof. Herein, in the circular dichroism spectrum, a native collagen and the peptide chain thereof that form the triple helical structure are known to characteristically show a positive Cotton effect in the range of approximately 220 to approximately 230 nanometers in the wavelength, and a negative Cotton effect in the range of approximately 195 to approximately 205 nanometers in the wavelength (J. Mol. Biol. Vol. 63 pp. 85-99, 1972).

The polymer of the invention preferably has the water absorbing properties. A saccharide residue(s) part in the polymer of the invention is rich in affinity with water. Therefore, the polymer as a whole can retain water.

Moreover, a water absorbing factor thereof can be controlled by adjusting the ratio of the PYG peptide unit(s) to the saccharide residue(s) derived from polysaccharides. Specifically, in a case where the water absorbing factor is desirably increased, a ratio of the saccharide residue(s) may be increased.

A method for measuring the water absorbing factor of the polymer of the invention is not particularly limited, but the ratio can be measured by a tea bag process, for example. First, a predetermined amount of dry polymer (A g) is weighed in a pre-weighed tea bag (C g) to immerse the tea bag into an excess amount of ion exchanged water, and to allow the tea bag to stand at 25° C. for 24 hours to swell the polymer. Next, after an excess amount of water is removed, a weight of water-absorbed and swollen polymer (B g) is measured, and the water absorbing factor is determined according to an equation: water absorbing factor=(B−A)/(A−C).

The polymer of the invention preferably has enzymatic degradation properties (enzymolysis properties). The reason is that the saccharide residue(s) part in the polymer of the invention may be cloven by the glycolytic enzyme in response to the polysaccharides from which the saccharide residue(s) is derived.

Moreover, the enzymolysis properties can be controlled by adjusting the ratio of the PYG peptide unit(s) to the saccharide residue(s) derived from polysaccharides. Specifically, in a case where the enzymolysis properties are desirably increased, the ratio of the saccharide residue(s) may be increased.

The polysaccharides from which the saccharide residue(s) as the essential constituent unit of the polymer of the invention is derived may be of various kinds, as described above. For example, in a case where the polysaccharides are hyaluronic acid, the polymer of the invention can be degraded by hyaluronidase. Moreover, in a case where the polysaccharides are carboxylmethyl cellulose, chondroitin sulfate, dextran, heparin and dermatan sulfate, the polymer of the invention can be degraded by cellulase, chondroitinase, dextranase, heparinase and chondroitinase, respectively.

A method for measuring the enzymolysis properties of the polymer of the invention is not particularly limited. For example, the enzymolysis properties can be measured by weighing a predetermined amount of dry polymer and then comparing a weight after being fully swollen with ion exchanged water with a weight after immersing the dry polymer into 200 U/mL of hyaluronidase PBS solution (pH: 6.0) at 37° C. for a fixed period of time.

The polymer of the invention has a good operability and mechanical strength, and safety, and can provide a material with the functions as described above, and therefore can be used without a particular limitation, regardless of a general use or a medical use, if the application is in the field in which the biomaterial, the collagen or the polysaccharides are used. For example, the polymer of the invention can be effectively used for controlled release of a functional material such as a medical agent, a wound healing agent, an anti-adhesive agent, a haemostatatic agent, or a cell scaffold material in regenerative medical treatment. When the polymer of the invention is provided for the applications, the polymer of the invention desirably includes the triple helical structure.

A process for producing the polymer of the invention is not particularly limited. For example, the polymer of the invention can be produced by synthesis including a step for allowing the condensation reaction between the peptide oligomer including the PYG peptide unit and the saccharide residue derived from polysaccharides.

The peptide oligomer including the PYG peptide unit as the raw material of the polymer of the invention can be chemically prepared according to an ordinary process such as a liquid phase process. As the peptide oligomer, an oligomer represented by formula (4) as described below can be used, for example, and an oligomer in which n is 1 is particularly easily used therefor from synthesis simplicity:

H-(Pro-Y-Gly)ₙ-OH (4)

wherein Y represents Pro or Hyp and n is an integer of 1 or more.

A weight ratio of the PYG peptide unit(s) to the saccharide residue(s) derived from polysaccharides in the polymer of the invention can be arbitrarily adjusted by changing the ratio of charging the peptide oligomer and the polysaccharides both being the raw materials in the condensation reaction in the production process of the invention. More specifically, in a case where the weight ratio is adjusted preferably in the range of approximately 95/5 to approximately 50/50, or further preferably, in the range of approximately 90/10 to approximately 60/40, as described above, the raw materials may be charged based on the weight ratio described above.

Moreover, in a case where the polymer of the invention has the further constituent unit, the peptide oligomer including the amino acid residue or the peptide unit, or alkylene, to be the further constituent unit, may be added to a condensation reaction system at an arbitrary weight ratio, and may be allowed to react together therewith.

The condensation reaction in the production process of the invention is ordinarily carried out in a solvent. The solvent is not particularly limited, if the solvent can dissolve the peptide oligomer and the polysaccharides both being the raw materials. For example, water or an organic solvent can be used therefor. Specific examples include water, amides (dimethylformamide, dimethylacetamide or hexamethylphosphoroamide), sulfoxides (dimethylsulfoxide), a nitrogen-containing cyclic compound (N-methylpyrrolidone or pyridine), nitriles (acetonitrile), ethers (dioxane or tetrahydrofuran), alcohols (methyl alcohol, ethyl alcohol or propyl alcohol), and a mixed solvent thereof. Among the solvents, water, dimethylformamide or dimethylsulfoxide is preferably used.

The condensation reaction in the production process of the invention is preferably carried out in the presence of a dehydration-condensation agent (dehydration agent), further preferably, in the presence of the dehydration-condensation agent and a condensation auxiliary. Thus, the condensation reaction progresses smoothly while suppressing dimerization or cyclization.

The dehydration-condensation agent that can be used in the production process of the invention is not particularly limited, as long as dehydration condensation can be efficiently performed in the solvent. Specific examples include a carbodiimide condensation agent (diisopropylcarbodiimide (DIPC),
1-ethyl-3-(3-dimethylaminopropyl)-carbodiimide (EDC=WSCI),
1-ethyl-3-(3-dimethylaminopropyl)-carbodiimide hydrochloride
(WSCI.HCl) or dicyclohexylcarbodiimide (DCC)), a fluorophosphate condensation agent
(O-(7-azabenzotriazole-1-yl)-1,1,3,3-tetramethyluronium hexafluorophosphate,
O-benzotriazole-1-yl-N,N,N′,N′-tetramethyluronium hexafluorophosphate,
benzotriazole-1-yl-oxy-tris-pyrrolidinophosphonium hexafluorophosphate,
benzotriazole-1-yl-tris(dimethylamino)phosphonium hexafluorophosphide (BOP)) or diphenylphosphoryl azide (DPPA).

The dehydration-condensation agents can be used alone or in the form of a mixture in combination with two or more kinds. A preferred dehydration-condensation agent includes a carbodiimide condensation agent (1-ethyl-3-(3-dimethylaminopropyl)-carbodiimide or 1-ethyl-3-(3-dimethylaminopropyl)-carbodiimide hydrochloride).

When a non-aqueous solvent without containing water is used, an amount of the dehydration-condensation agent used in the production process of the invention is ordinarily in the range of approximately 0.7 to approximately 5 mol, preferably, in the range of approximately 0.8 to approximately 2.5 mol, further preferably, in the range of approximately 0.9 to approximately 2.3 mol (approximately 1 to approximately 2 mol, for example), based on 1 mol of the total amount of the peptide oligomer. In a water-containing solvent (aqueous solvent), inactivation of the dehydration-condensation agent by water is caused. Therefore, an amount of the dehydration-condensation agent used therein is ordinarily in the range of approximately 2 to approximately 500 mol, preferably, in the range of approximately 5 to approximately 250 mol, further preferably, in the range of approximately 10 to approximately 125 mol, based on 1 mol of the total amount of peptide fragments.

The condensation auxiliary that can be used in the production process of the invention is not particularly limited, as long as the auxiliary promotes the condensation reaction. Specific examples include N-hydroxypolycarboxylic imides
(N-hydroxysuccinimide (HONSu), N-hydroxydicarboxylic imides such as
N-hydroxy-5-norbornene-2,3-dicarboxylic imides (HONB)),
N-hydroxytriazoles (N-hydroxybenzotriazoles such as
1-hydroxybenzotriazole (HOBt)), triazines such as
3-hydroxy-4-oxo-3,4-dihydro-1,2,3-benzotriazine (HOObt) or
2-hydroxyimino-2-cyanoacetic acid ethyl ester.

The condensation auxiliaries can also be used alone or in combination with two or more kinds. A preferred condensation auxiliary includes N-hydroxydicarboxylic imides (HONSu), N-hydroxybenzotriazole or N-hydroxybenzotriazines (HOBt).

An amount of the condensation auxiliary used in the production process of the invention is ordinarily in the range of approximately 0.5 to approximately 5 mol, preferably, in the range of approximately 0.7 to approximately 2 mol, further preferably, in the range of approximately 0.8 to approximately 1.5 mol, based on 1 mol of the total amount of the peptide oligomer, regardless of kinds of solvents.

In the production process of the invention, the dehydration-condensation agent and the condensation auxiliary are preferably suitably combined and used. Specific examples of a preferred combination of the dehydration-condensation agent and the condensation auxiliary include a combination of DCC and HONSu (HOBt or HOOBt) or a combination of WSCI and HONSu (HOBt or HOOBt).

In the condensation reaction in the production process of the invention, pH of a reaction solution may be adjusted, and pH is ordinarily adjusted at a vicinity of neutrality (pH: approximately 6 to approximately 8). Adjustment of pH can be ordinarily performed using an inorganic base (sodium hydroxide, potassium hydroxide, sodium carbonate, sodium hydrogencarbonate or the like), an organic base, an inorganic acid (hydrochloric acid or the like) or an organic acid.

Moreover, a base that is not involved in the condensation reaction may be added to the reaction solution. Specific examples of the bases that are not involved in the condensation reaction include tertiary amines such as trialkylamines including trimethylamine, triethylamine or diisopropylethylamine, or heterocyclic tertiary amines including N-methylmorpholine or pyridine. An amount of such a base used therein can be ordinarily selected from the range of approximately 1 to 2 times of the total number of moles of the peptide oligomer.

Temperature at which the condensation reaction in the production process of the invention is carried out is not particularly limited. However, when the dehydration-condensation agent is added, cooling at approximately 4° C. or lower is preferred in order to suppress heat generation. Moreover, after the condensation agent is added and stirred, a reaction mixture is preferably allowed to stand.

In a case where the dehydration-condensation agent and the condensation auxiliary are used in the condensation reaction, the agent and the auxiliary remain in the resultant polymer. Therefore, the polymer is preferably washed with the solvent after a condensation reaction step.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

In the following, the invention will be explained in greater detail by way of Examples, but the invention is in no way limited to the Examples.

### Example 1

### Production of a Polymer of the Invention

A polymer of the invention was produced by carrying out a condensation reaction using a peptide oligomer represented by H-Pro-Hyp-Gly-OH (hereinafter, described as a PHG peptide oligomer, or simply as PHG) and hyaluronic acid (hereinafter, occasionally described as HA), or carboxylmethyl cellulose (hereinafter, occasionally described as CMC) (Production Examples 1 to 11). In addition, in Production Examples 9 and 10, glycine or lysine was also added to a raw material as an amino acid residue of a further constituent unit. Moreover, by way of comparison, a polymer was also produced by carrying out a condensation reaction using only the PHG peptide oligomer (Comparative Production Example 1).

### Production Example 1

### PHG/HA=95/5

In 20 mL of 10 mM phosphate buffer (pH: 7.4), 0.95 g of PHG peptide oligomer prepared according to a liquid phase process and 0.05 g of hyaluronic acid (Lot No. 065910, an average molecular weight: 1,150,000, made by JNC Corporation) were dissolved, and the resultant solution was cooled to 4° C. Thereto, 88 mg of 1-hydroxybenzotriazole (made by EIWEISS Chemical Corporation) at 4° C., and 3.16 g of 1-ethyl-3-(3-dimethylaminopropyl)-carbodiimide hydrochloride (made by EIWEISS Chemical Corporation) at 4° C. were added and stirred well at 4° C., and then an operation was shifted to still standing, and the resultant mixture was allowed to stand at 20° C. for 24 hours, and the polymer of the invention was obtained. After completion of the reaction, the polymer was immersed into 200 mL of 50 wt. % ethanol aqueous solution for 24 hours, and an impurity was removed. On the occasion, the 50 wt. % ethanol aqueous solution was exchanged using a fresh 50 wt. % ethanol aqueous solution after 2 hours and 6 hours. Furthermore, the polymer was immersed into 200 mL of pure water for 24 hours, and the polymer was washed. On the occasion, pure water was exchanged using fresh pure water after 2 hours and 6 hours from starting immersion. After completion of washing, a dry sponge-like polymer was obtained by lyophilizing the polymer.

### Production Example 2

### PHG/HA=90/10

A polymer of the invention was obtained by performing an operation in a manner similar to Production Example 1 except that 0.9 g of PHG peptide oligomer and 0.1 g of hyaluronic acid (Lot No. 065910, an average molecular weight: 1,150,000, made by JNC Corporation) were used in place thereof in Production Example 1.

### Production Example 3

### PHG/HA=60/40

A polymer of the invention was obtained by performing an operation in a manner similar to Production Example 1 except that 0.6 g of PHG peptide oligomer and 0.4 g of hyaluronic acid (Lot No. 065910, an average molecular weight: 1,150,000, made by JNC Corporation) were used in place thereof in Production Example 1.

### Production Example 4

### PHG/CMC=95/5

In 20 mL of 10 mM phosphate buffer (pH: 7.4), 0.95 g of PHG peptide oligomer prepared according to a liquid phase process and 0.05 g of carboxylmethyl cellulose (selling agency code: 039-01335, made by Wako Pure Chemical Industries, Ltd.) were dissolved, and the resultant solution was cooled to 4° C. Thereto, 88 mg of 1-hydroxybenzotriazole (made by EIWEISS Chemical Corporation) at 4° C., and 3.16 g of 1-ethyl-3-(3-dimethylaminopropyl)-carbodiimide hydrochloride (made by EIWEISS Chemical Corporation) at 4° C. were added and stirred well at 4° C., and then an operation was shifted to still standing, and the resultant mixture was allowed to stand at 20° C. for 24 hours, and the polymer of the invention was obtained. After completion of the reaction, the polymer was immersed into 200 mL of 50 wt. % ethanol aqueous solution for 24 hours, and an impurity was removed. On the occasion, the 50 wt. % ethanol aqueous solution was exchanged using a fresh 50 wt. % ethanol aqueous solution after 2 hours and 6 hours. Furthermore, the polymer was immersed into 200 mL of pure water for 24 hours, and the polymer was washed. On the occasion, pure water was exchanged using fresh pure water after 2 hours and 6 hours from starting immersion. After completion of washing, a dry sponge-like polymer was obtained by lyophilizing the polymer.

### Production Example 5

### PHG/CMC=90/10

A polymer of the invention was obtained by performing an operation in a manner similar to Production Example 4 except that 0.9 g of PHG peptide oligomer and 0.1 g of carboxylmethyl cellulose were used in place thereof in Production Example 4.

### Production Example 6

### PHG/CMC=60/40

A polymer of the invention was obtained by performing an operation in a manner similar to Production Example 4 except that 0.6 g of PHG peptide oligomer and 0.4 g of carboxylmethyl cellulose were used in place thereof in Production Example 4.

### Production Example 7

### PHG/HA=71.4/28.6

In a glass vessel, 0.321 g of PHG peptide oligomer containing 6.45 wt. % of moisture (net weight of peptide oligomer: 0.301 g), 28.8 mg of 1-hydroxybenzotriazole (made by EIWEISS Chemical Corporation), and 16.612 g of ion exchanged water were weighed and stirred to yield a homogeneous solution. Thereto, 12.1 g of 1.0 wt. % aqueous solution of sodium hyaluronate (Lot No. HB 9002, limiting viscosity: 20.6 dl/g, made by JNC Corporation) that was independently prepared (net weight of sodium hyaluronate: 0.121 g) was added and stirred to yield a homogeneous solution. Subsequently, under ice-cooling, 1.009 g of 1-ethyl-3-(3-dimethylaminopropyl)-carbodiimide hydrochloride (made by EIWEISS Chemical Corporation) was added and stirred to yield a homogeneous solution, and then 20.557 g of reaction mixture was immediately transferred to a Teflon (registered trademark) vessel (75×135 mm), and the resultant mixture was allowed to stand at 20° C. for 24 hours, and a polymer of the invention was obtained. After completion of the reaction, the polymer together with the Teflon (registered trademark) vessel was immersed into 6 L of ion exchanged water for 3 hours or more, and an operation for removing an impurity was repeated 3 times. After completion of washing, 110.833 g of hydrogel was obtained. Then, 0.231 g of dry sponge-like polymer was obtained by further lyophilizing the hydrogel.

### Production Example 8

### PHG/HA=83.3/16.7

A polymer of the invention was obtained by performing an operation in a manner similar to Production Example 7 except that 0.647 g of PHG peptide oligomer (net weight of peptide oligomer weight: 0.605 g), and 12.0 g of 1.0 wt. % aqueous solution of sodium hyaluronate (net weight of sodium hyaluronate: 0.120 g) were used in place thereof in Production Example 7. After completion of washing, 28.338 g of translucent hydrogel was obtained. Then, 0.392 g of dry sponge-like polymer was obtained by further lyophilizing the hydrogel.

### Production Example 9

### PHG/HA/Gly=82.0/16.4/1.6

In a glass vessel, 1.287 g of PHG peptide oligomer containing 6.45 wt. % of moisture (net weight of peptide oligomer: 1.200 g), 0.113 g of 1-hydroxybenzotriazole (made by EIWEISS Chemical Corporation), 2.410 g of 1.0 wt. % aqueous solution of L-glycine (made by Wako Pure Chemical Industries, Ltd.) that was independently prepared (net weight of L-glycine: 0.024 g), and 28.209 g of ion exchanged water were weighed and stirred to yield a homogeneous solution. Thereto, 23.942 g of 1.0 wt. % aqueous solution of sodium hyaluronate (Lot No. HA9002, limiting viscosity: 18.6 dl/g, made by JNC Corporation) that was independently prepared (net weight of sodium hyaluronate: 0.240 g) was added and stirred to yield a homogeneous solution. Subsequently, under ice-cooling, 4.062 g of 1-ethyl-3-(3-dimethylaminopropyl)-carbodiimide hydrochloride (made by EIWEISS Chemical Corporation) was added and stirred to yield a homogeneous solution, and then 28.7 g of reaction mixture was immediately transferred to a plastic petri dish (diameter: 86 mm), and the mixture was allowed to stand at room temperature for 24 hours, and a polymer of the invention was obtained. After completion of the reaction, the polymer was removed from the petri dish, and immersed into 3 L of ion exchanged water for 3 hours or more, and an operation for removing an impurity was repeated 3 times. After completion of washing, 57.35 g of transparent hydrogel was obtained. Then, 0.197 g of dry sponge-like polymer was obtained by lyophilizing 21.91 g of the hydrogel.

### Production Example 10

### PHG/HA/Lys=82.6/16.5/0.9

In a glass vessel, 1.069 g of PHG peptide oligomer containing 6.45 wt. % of moisture (net weight of peptide oligomer: 1.000 g), 0.95 g of 1-hydroxybenzotriazole (made by EIWEISS Chemical Corporation), 1.0 g of 1.0 wt. % aqueous solution of L-lysine hydrochloride (made by Wako Pure Chemical Industries, Ltd.) that was independently prepared (net weight of L-lysine hydrochloride: 0.010 g), and 24.38 g of ion exchanged water were weighed and stirred to yield a homogeneous solution. Thereto, 20.0 g of 1.0 wt. % aqueous solution of sodium hyaluronate (Lot No. HA9002, limiting viscosity: 18.6 dl/g, made by JNC Corporation) that was independently prepared (net weight of sodium hyaluronate: 0.20 g) was added and stirred to yield a homogeneous solution. Subsequently, under ice-cooling, 3.36 g of 1-ethyl-3-(3-dimethylaminopropyl)-carbodiimide hydrochloride (made by EIWEISS Chemical Corporation) was added and stirred to yield a homogeneous solution, and then 17.22 g of reaction mixture was immediately transferred to a plastic petri dish (diameter: 86 mm), the mixture was allowed to stand at room temperature for 24 hours, and a polymer of the invention was obtained. After completion of the reaction, 9.424 g of polymer was removed from the petri dish, and immersed into 5 L of ion exchanged water for 3 hours or more, and an operation for removing an impurity was repeated 3 times. After completion of washing, 21.804 g of hydrogel was obtained. The hydrogel had a softer feel, as compared with the products according to other Production Examples. Then, 0.2014 g of dry sponge-like polymer was obtained by lyophilizing the hydrogel.

### Production Example 11

### PHG/HA=40/60

In a glass vessel, 0.40 g of PHG peptide oligomer, 0.60 g of hyaluronic acid (Lot No. 065910, an average molecular weight: 1,150,000, made by JNC Corporation), 0.043 g of 1-hydroxybenzotriazole (made by EIWEISS Chemical Corporation), and 18 ml of ion exchanged water were weighed to yield a homogeneous solution. After transferring 17.13 g of the mixed solution to a plastic petri dish (diameter: 86 mm), 1.33 g of 1-ethyl-3-(3-dimethylaminopropyl)-carbodiimide hydrochloride (made by EIWEISS Chemical Corporation) that was dissolved in 2 mL of ion exchanged water was added and stirred. Viscosity of the solution was high and the operation of stirring was difficult. However, a homogeneous solution was formed, and then was allowed to stand at room temperature for 24 hours, and a polymer of the invention was obtained.

### Comparative Production Example 1

### PHG/HA=100/0

In a glass vessel, 2.0 g of PHG peptide oligomers and 0.2 g of 1-hydroxybenzotriazole (made by EIWEISS Chemical Corporation) were weighed, 40 mL of ion exchanged water was added thereto and stirred to yield a homogeneous solution. Subsequently, under ice-cooling, 6.7 g of 1-ethyl-3-(3-dimethylaminopropyl)-carbodiimide hydrochloride (made by EIWEISS Chemical Corporation) was added and stirred well at 4° C., a reaction mixture was immediately transferred to a plastic petri dish (diameter: 86 mm), and allowed to stand at room temperature for 24 hours, and a polymer essentially consisting of polyPHG was obtained. When the reaction product was removed from the petri dish and immersed into ion exchanged water, the reaction product was not gelled.

### Example 2

### Measurement of a Circular Dichroism Spectrum

When a circular dichroism spectrum was measured using Spectropolarimeter J-820 (optical path length: 1 mm, made by JASCO Corporation) for a suspension liquid of each polymer obtained according to Production Examples 1 to 10 in which each polymer was fully dispersed to be 0.025% by weight with ion exchange water, a positive Cotton effect was observed at 227 nanometers, a negative Cotton effect was observed at 200 nanometers, and formation of a triple helical structure was confirmed for all polymers.

### Example 3

### Measurement of a Water Absorbing Factor

First, 0.2 g of each of dry polymers produced according to Production Examples 1 to 6 was weighed to a pre-weighed tea bag (C g), and weight (A g) was measured, and then the tea bag was immersed into 100 mL of pure water for 24 hours. Next, redundant water was removed, and then weight (B g) of water-absorbed and swollen polymer was measured, and a water absorbing factor was determined according to an equation: water absorbing factor=(B−A)/(A−C).

The water absorbing factor of the polymer is shown in Table 1. Table 1 shows that the water absorbing factor of the polymer can be adjusted by changing an amount of charging the PHG peptide oligomer and hyaluronic acid or carboxylmethyl cellulose.

In general, in a swollen polymer, strength is increased if the water content in the polymer is lower, and conversely, the strength is decreased if the water content therein is higher. In Table 1, the strength is increased in a polymer having a smaller water absorbing factor, namely, the polymer having a lower water content, and the strength is decreased in a polymer having a larger water absorbing factor, namely, the polymer having a higher water content. Accordingly, strength of the swollen polymer can also be adjusted by changing an amount of charging the PHG peptide oligomer and hyaluronic acid or carboxylmethyl cellulose.

In addition, the polymer according to Comparative Production Example 1 was not gelated, and measurement of a water absorbing factor and an evaluation of strength were quite difficult. Moreover, an evaluation was attempted also on a gel essentially consisting of sodium hyaluronate as Reference Example. However, although the gel sufficiently absorbed water, the gel was swollen and collapsed to keep no shape. Therefore, the gel was judged to have a poor mechanical strength.

TABLE 1

| Polymer | | | |
|---|---|---|---|
| (Weight ratio of charged | Dry gel | Swollen gel | Water absorbing |
| raw materials) | (g) | (g) | factor |
| Production Example 1 | 0.2 | 8.2 | 40.4 |
| (PHG/HA = 95/5) | | | |
| Production Example 2 | 0.2 | 10.6 | 52.4 |
| (PHG/HA = 90/10) | | | |
| Production Example 3 | 0.2 | 14.9 | 72.9 |
| (PHG/HA = 60/40) | | | |
| Production Example 4 | 0.2 | 8.4 | 40.4 |
| (PHG/CMC = 95/5) | | | |
| Production Example 5 | 0.2 | 6.7 | 33.1 |
| (PHG/CMC = 90/10) | | | |
| Production Example 6 | 0.2 | 3.5 | 16.6 |
| (PHG/CMC = 60/40) | | | |

### Example 4

### Enzymolysis of a Polymer of the Invention

Then, 20 mg of each of polymers produced according to Production Examples 1 to 3 was accurately weighed, and immersed into 20 mL of ion exchanged water for 24 hours, and swollen. After measuring the weight after being swollen, the polymer was immersed into 200 U/ml of PBS solution (pH: 6.0) of hyaluronidase derived from bovine testes (made by Sigma-Aldrich Corporation) at 37° C., and a weight loss was measured with time. For comparison, 20 mg of the polymer of PHG carboxylmethyl cellulose produced according to Production Example 6 was also immersed thereinto in a similar manner, the weight after being swollen was measured, and then the weight loss was measured.

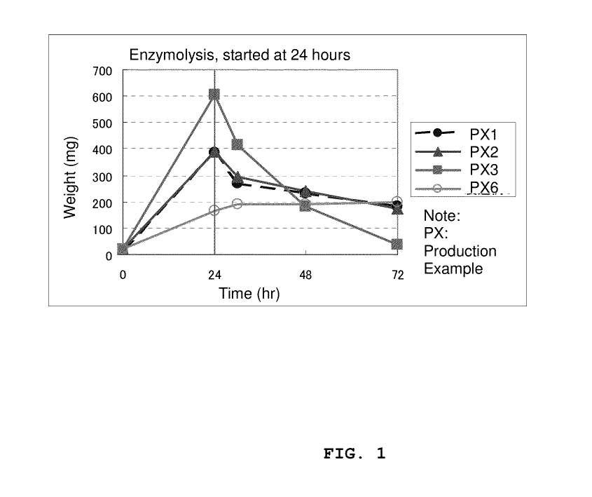

The measurement results are shown in FIG. 1. FIG. 1 shows that a rate of degradation of the polymer with hyaluronidase can be adjusted by changing an amount of charging the PHG peptide oligomer and hyaluronic acid.

The results similar thereto were obtained also in a case where enzymolysis was performed using cellulase, chondroitinase and dextranase in a similar manner for a polymer prepared using carboxylmethyl cellulose, chondroitin sulfate and dextran as the polysaccharides.

When a circular dichroism spectrum was measured using Spectropolarimeter J-820 (optical path length: 1 mm, made by JASCO Corporation) for a solution obtained by degrading with hyaluronidase the polymer obtained according to each Production Example, a positive Cotton effect was observed at 227 nanometers, a negative Cotton effect was observed at 200 nanometers, and formation of a triple helical structure was confirmed.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

### INDUSTRIAL APPLICABILITY

A novel polymer of the invention has both various characteristics of a collagen-like polypeptide suitable for a biomaterial, and characteristics of polysaccharides, namely, a high hydrophilicity and enzymolytic degradation, and also has a high mechanical strength and water absorbing properties. Moreover, a peptide relating to the invention is an artifact, and therefore has no concern of a risk of infection by a pathogenic organism. Furthermore, the water absorbing properties and enzymolysis properties of the resultant polymer can be controlled by changing an amount of charging the peptide oligomer and the polysaccharides in a condensation reaction.

Accordingly, the invention provides an excellent biomaterial having a good operability and a high safety. Thus, the polymer can be very effectively used for controlled release of a functional material such as a medical agent, a wound healing agent, an anti-adhesive agent, a haemostatatic agent, or a cell scaffold material in regenerative medical treatment.

1. A polymer having one or more peptide units represented by formula (1) and one or more saccharide residues derived from polysaccharides:
-(Pro-Y-Gly)ₙ- (1)
wherein Y represents Pro or Hyp and n is an integer of 1 or more.

2. The polymer according to claim 1, comprising a triple helical structure.

3. The polymer according to claim 1, wherein a weight ratio of the peptide unit(s) to the saccharide residue(s) is in the range of 95/5 to 50/50.

4. The polymer according to claim 1, wherein the polysaccharides are selected from hyaluronic acid, carboxylmethyl cellulose, chondroitin sulfate, dextran, heparin and dermatan sulfate.

5. The polymer according to claim 1, further having one or more amino acid residues or one or more peptide units, in addition to the peptide unit(s).

6. The polymer according to claim 5, wherein the further amino acid residue(s) is/are a glycine residue(s) or a lysine residue(s).

7. The polymer according to claim 1, wherein the peptide unit and the saccharide residue derived from the polysaccharides are bonded between a carboxyl group thereof and an amino group thereof.

8. A process for producing the polymer according to claim 1, comprising a step for allowing a condensation reaction between a peptide oligomer including the peptide unit represented by formula (1) and the polysaccharides.


SEQUENCE LISTING (1 sequence)

SEQ ID NO: 1 - protein, 5 aa, Artificial Sequence
  Peptide unit
VPGVG